(19) United States
(12) Patent Application Publication
(10) Pub. No.: US 2009/0210695 A1
(43) Pub. Date: Aug. 20, 2009

(54) SYSTEM AND METHOD FOR SECURELY COMMUNICATING ELECTRONIC DOCUMENTS TO AN ASSOCIATED DOCUMENT PROCESSING DEVICE

(76) Inventors: Amir Shahindoust, Laguna Niguel, CA (US); David Honig, Irvine, CA (US); Michael Yeung, Mission Viejo, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/400,876

(22) Filed: Mar. 10, 2009

Related U.S. Application Data
(63) Continuation-in-part of application No. 11/030,687, filed on Jan. 6, 2005, now Pat. No. 7,502,466.

(51) Int. Cl. G06F 17/00; H04L 29/06

(52) U.S. Cl. 713/150; 715/234

(57) ABSTRACT

The subject application is directed to securely communicating electronic documents to an associated document processing device. User identification data inclusive of a user credential is received from a user with a document processing request having one or more electronic documents. Page job language information is generated for output of the request by a document processing device. A seed value is received in accordance with the user credential and used to generate a random number. Each document is encrypted using the random number. The encrypted data and page language information are communicated to the document processing device and stored in association with user identification. Upon receipt of user login data a listing of requests is displayed. The seed value is retrieved from user credentials for generation of a random number. Selected electronic documents are decrypted via the random number and output in accordance with the associated page job language information.

### CROSS-REFERENCE TO RELATED APPLICATIONS

This application is a continuation-in-part of U.S. patent application Ser. No. 11/030,687, titled A SYSTEM AND METHOD FOR SECURE COMMUNICATION OF ELECTRONIC DOCUMENTS, filed on Jan. 6, 2005.

### BACKGROUND OF THE INVENTION

The subject application is directed generally to the secure communication of electronic documents. The subject application is particularly applicable to enabling secure data communication of a user's electronic documents without the user's intervention.

Document processing devices are routinely used in a network environment to generate or propagate electronic documents. One issue facing such environments is that the electronic document is able to be sniffed or intercepted by hackers or other unauthorized users. This is even more of an issue in those environments which allow wireless communication with the document processing devices. There is a need for a data security mechanism to deter or prevent unauthorized access to such electronic documents. Document transmission is suitably in conjunction with document forwarding, document storage, or document processing operations, such as printing, facsimile transmission, scanning, and the like.

Typically an encryption/decryption mechanism is used wherein a key is generated by a standard algorithm and the key is then used to encrypt and decrypt the electronic document. One problem with such encryption/decryption mechanisms is that the security of the encrypted document depends on the security level of the key. The algorithms used to generate the key are generally standard or well known and anyone skilled in the art could use the algorithms to decrypt the data is such person is able to determine the key.

Another problem with standard encryption/decryption mechanisms is that the exchange of the key between the encryption device and the decryption typically requires two-way communication between the devices. For example, SSL requires bi-directional communication and RSA public key methods require prior key distribution. It would be advantageous to have an encryption/decryption mechanism which only required unidirectional communication. One such option is to use a fix hard coded key that is used by the client device or use and the document processing device. However, there is minimal security in such a method as the key is easily determined by trial and error or by reverse engineering.

### SUMMARY OF THE INVENTION

In accordance with one embodiment of the subject application, there is provided a system and method for securely communicating electronic documents to an associated document processing device. User identification data representing at least one user credential is received from an associated user at a user device. A seed value is then received corresponding to the at least one user credential associated with the received user identification data. A first document processing request is then received at the user device that includes an unencrypted electronic document. Page job language information corresponding to the first document processing request is then generated for controlling operation of an associated document processing device. A random number is then generated from the seed value associated with the user credential. The document data is then encrypted using the random number so as to generate encrypted document data. The encrypted document data and page job language information associated with the first document processing request is then communicated via a user interface of the user device to a document processing device. At least one additional document processing request is then received at the user device, the request inclusive of electronic document data representing an unencrypted electronic document. Page job language information corresponding to the at least one additional document processing request is then generated for the control of the document processing device. The document data is then encrypted in accordance with the random number so as to generate encrypted document data. The encrypted document data and page job language information associated with the additional document processing request is then communicated to the document processing device.

According to one embodiment of the subject application, the encrypted document data and page job language data associated with each document processing request is first received by the document processing. Each received document processing request is then stored at the document processing device in association with user identification data. Login data is then received via the user interface that includes at least one user credential. The received login data is then compared to user identification data associated with each stored document processing request. Display data is then generated via the document processing device user interface corresponding to each document processing request in accordance with the results of the comparison. Selection data is then received from the associated user corresponding to at least one displayed document processing request. A seed value corresponding to the at least one user credential is then retrieved and a random number is generated from the at least one seed value by the document processing device. The document processing device then decrypts each encrypted electronic document in accordance with the generated random number corresponding to the received selection data. A document processing operation is then commenced on each decrypted electronic document in accordance with a received document processing request and associated job page language information.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain parts, and arrangements to parts, which are evidenced in conjunction with the associated drawings, which form a part hereof and not, for the purposes of limiting the same in which:

FIG. 1 is a block diagram illustrative of the system in accordance with one embodiment of the subject application;

FIG. 2 is a flowchart illustrating encryption process according to one embodiment of the subject application;

FIG. 3 is a flowchart illustrating the decryption process according to one embodiment of the subject application;

FIG. 4 is a flowchart illustrating an encryption portion of a method for securely communicating electronic documents to an associated document processing device in accordance with one embodiment of the subject application; and

FIG. 5 is a flowchart illustrating a decryption portion of a method for securely communicating electronic documents to an associated document processing device in accordance with one embodiment of the subject application.

### DETAILED DESCRIPTION OF THE PREFERRED EMBODIMENT

The subject application is directed to a system and method for secure communication of electronic documents. More particularly, the subject application is directed to a system and method for secure data communication of a user's electronic documents without the user's intervention. The system and method enable secure communication of electronic documents to an associated document processing device which uses an encryption/decryption mechanism only requiring unidirectional communication between the user device or client module and the document processing device and which is transparent to the user.

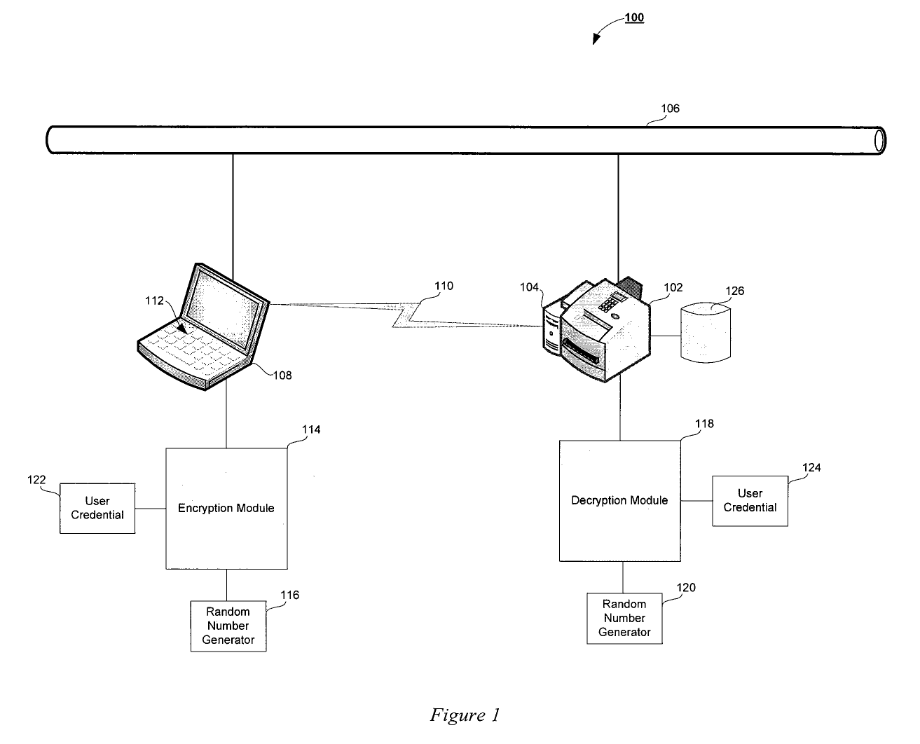

FIG. 1 illustrates a block diagram preferred embodiment of the system according to the subject application generally designated as 100. The system comprises at least one document processing device 102, as illustrated by a multifunction peripheral device, for generating or processing image data. It is to be appreciated that the document processing device 102 is any suitable document processing device known in the art, such as a copier, printer, scanner, facsimile and the like, or any combination thereof. Suitable commercially available document processing peripherals include, but are not limited to, the Toshiba e-Studio Series Controller.

The document processing device 102 of the system 100 further comprises a controller 104, which controls the functions of the document processing device 102 as will be appreciated by one of ordinary skill in the art. The controller 104 is capable of being externally or internally coupled to the document processing device 102. The controller 104 is advantageously any hardware, software, or combination thereof suitably capable of controlling the functioning of the document processing device 102 as will be appreciated by one of ordinary skill in the art.

Preferably, the document processing device 102 is communicatively coupled to a computer network 106. The computer network 106 includes at least one computer, workstations, wireless devices, or other suitable user device 108 which enables the user to communicate and use the capabilities of the document processing device 102. It is understood that the computer network 106 may suitably comprise additional computers, workstations, wireless devices, or other suitable device by which the user is able to communicate with and use the capabilities of the document processing device 102.

Communicatively coupled to the document processing device 102 is a data storage device 126. In accordance with the one embodiment of the subject application, the data storage device 126 is any mass storage device known in the art including, for example and without limitation, magnetic storage drives, a hard disk drive, optical storage devices, flash memory devices, or any suitable combination thereof. In one embodiment, the data storage device 126 is suitably adapted to store scanned image data, modified image data, redacted data, user information, cellular telephone data, pre-set payment data, document data, image data, electronic database data, or the like. It will be appreciated by those skilled in the art that while illustrated in FIG. 1 as being a separate component of the system 100, the data storage device 126 is capable of being implemented as an internal storage component of the document processing device 102, a component of the controller 104, or the like, such as, for example and without limitation, an internal hard disk drive, or the like. In accordance with one embodiment of the subject application, the data storage device 126 is capable of storing document processing instructions, page job language information, user information, document processing requests, secured output lists, usage data, user interface data, job control data, documents, images, spreadsheets, multimedia data files, fonts, and the like.

The network 106 is suitably any suitable network known in the art, for example and without limitation, Ethernet, Token Ring, or the Internet. The user device 108 transmits data to the document processing device 102 through the controller 104 over the computer network 106. It will be appreciated by those skilled in the art that the document processing device 102 need not be coupled to the computer network 106, but rather is suitably in a stand-alone mode, i.e. connected to a single computer or user device. The skilled artisan will understand that such a stand-alone configuration will not affect the operation of the subject application with respect thereto.

The user device 108 communicates with the controller 104 of the document processing device 102 via a suitable communications link 110. As will be understood by those skilled in the art, the communications link 110 is any means for communication between two electronic devices, for example and without limitation, 802.x, an Ethernet based network, infrared connection, Wi-Fi connection, telephone connection, cellular telephone connection, Bluetooth connection and the like. The skilled artisan will appreciate that the communications link 110 is capable of being implemented over a computer network 106 or by directly connecting the user device 108 to the controller 104 of the document processing device 102.

Preferably, the user device 108 includes an associated user interface 112 by which an associated user requests document processing operations and selects the parameters associated therewith. The user interface 112 preferably includes a display means for displaying information related to secure document processing. It will be appreciated that viable user interfaces suitably take various forms, such as touch screen, keypads, pen input, and the like.

In the preferred embodiment, the user device 108 is also in data communication with an encryption module 114 to encrypt the electronic document data to be transmitted to the document processing device 102. The encryption module 114 is capable of being externally or internally coupled to the user device. Preferably, the encryption module includes a random number generator 116 for generating random numbers to serve as a key to use to encrypt the electronic document data. The random number generator 116 is suitably either externally or internally coupled to the encryption module 114. As will be appreciated by one of ordinary skill in the art, conventional random number generators typically require that a starting value or seed be input. The seed value allows for generation of a string of random numbers. If a specific generator is used, the same string of random numbers will be generated each time operation is commenced with a specified seed value. At least one user credential 122 is also illustrated in FIG. 1, available to the encryption module 114 for use in determining the appropriate seed value for use in accordance with the system and method of the subject application. It will be appreciated by those skilled in the art that suitable user credentials include, for example and without limitation, usernames, passwords, certificates, and the like.

Preferably, the document processing device 102 is in data communication with a decryption module 118 to decrypt the electronic document data to regenerate the electronic document data for document processing. The decryption module 118 is suitably a stand-alone component or integrated into the controller 104 of the document processing device 102. The decryption module 118 incorporates a random number generator 120, which random number generator employs the same generator as that of random number generator 116. Thus when random number generator 120 is supplied with the same seed value used by random number generator 116, the same key will be generated. Thus, the system provides for secure transmission of encrypted document data and a seed value that is of no use for decryption unless the precise random number generator is also known. At least one user credential 124 is also illustrated in FIG. 1, available to the decryption module 118 for use in determining the appropriate seed value for use in accordance with the system and method of the subject application. It will be appreciated by those skilled in the art that suitable user credentials include, for example and without limitation, usernames, passwords, certificates, and the like.

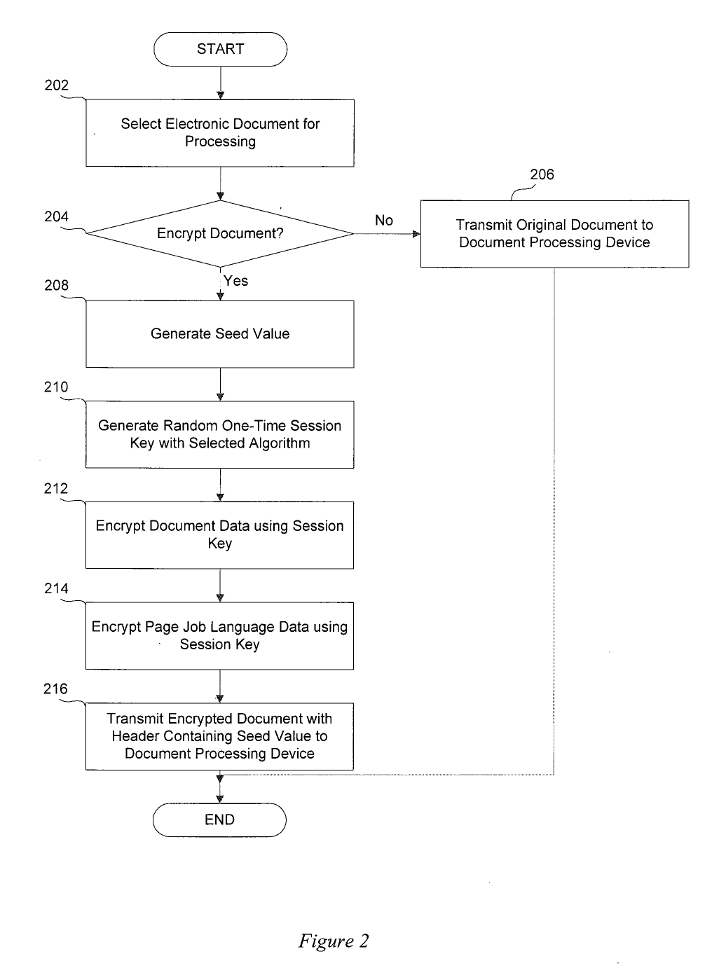

FIG. 2 is a flowchart illustrating the encryption process according to one embodiment of the subject application. At 202, a user selects an electronic document for document processing via the user device. At 204, a determination is made via any suitable means whether the electronic document is to be encrypted prior to transmission to the document processing device. For example, when selecting the parameters for the document processing operation, the user may select whether the document is to be encrypted. In another embodiment, the system is suitably configured such that certain types of document are encrypted, documents transmitted from certain user devices are encrypted, documents generated by certain users are encrypted, or all documents are encrypted.

If the electronic document is not to be encrypted, then flow proceeds to 206, wherein the original document, without encryption, is transmitted to the document processing device. If the electronic document is to be encrypted, flow proceeds to 208 wherein a specified seed value is generated via any suitable means, such as via a user selection table, operation specific values, site specific values, or the like. Also, values, such as a time stamp on the document suitably also serve as a suitably seed value. Preferably, a platform specific random number generator generates the seed value. At 210, the seed value is then subjected to a selected algorithm via any suitable means to generate a random one-time session key.

At 212, the random session key is used to encrypt the electronic document data via any suitable means. As will be appreciated by those skilled in the art, in the preferred embodiment, the present invention makes use of the Triple-Data Encryption Standard (“3DES”) encryption algorithm. This governmental standard is contained in the standards document number ANSI X9.52-1998 Public Key Cryptography For The Financial Services Industry: Triple Data Encryption Algorithm Modes of Operation, incorporated herein. Other suitable encryption algorithms include Advanced Encryption Standard, Riverst-Shamir-Adelman (RSA), Diffie-Hellman, Digital Signature Standard (DSS), ElGamal, LUC, Blowfish, International Data Encryption Algorithm (IDEA), RC4, SAFER, and Enigma.

At 214, the random session key is also used to encrypt information related to electronic document, such as the page job language information. Preferably, the seed value is also encrypted. Preferably, the encrypted page job language information and encrypted seed value is appended to the electronic document as a header.

At 216, the encrypted electronic document with the header containing the encrypted related information and seed value are transmitted to the document processing device via any suitable means.

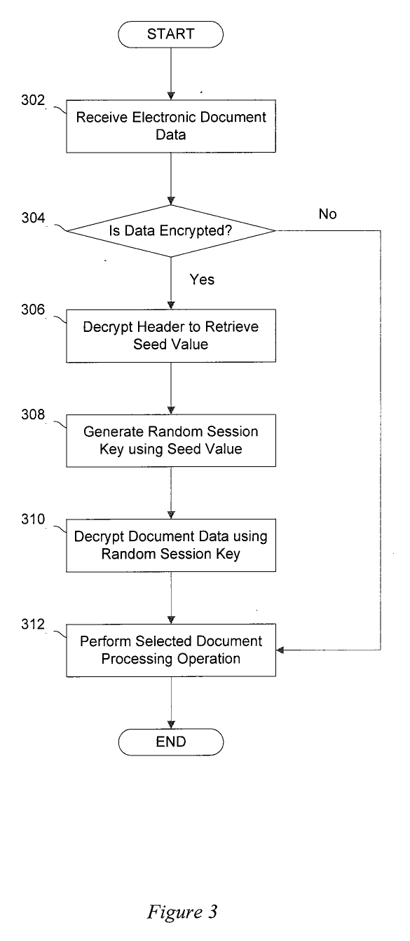

FIG. 3 is a flowchart illustrating the decryption process according to one embodiment of the subject application. At 302, electronic document data is received at the document processing device. At 304, a determination is made whether the electronic document data is encrypted. If the document is not encrypted, flow proceeds to 312, wherein the selected document processing operation is performed on the electronic document data.

If the document is encrypted, flow proceeds to 306, wherein the header containing the encrypted seed value is decrypted via any suitable means. Once the seed value has been decrypted, the seed value is used to generate the random session key as shown at 308. The seed value is subjected to a selected algorithm via any suitable means to generate a random one-time session key.

At 310, the electronic data is decrypted using the random session key via any suitable means to regenerate the electronic document data. At 312, the selected document processing operation is performed on the electronic document data.

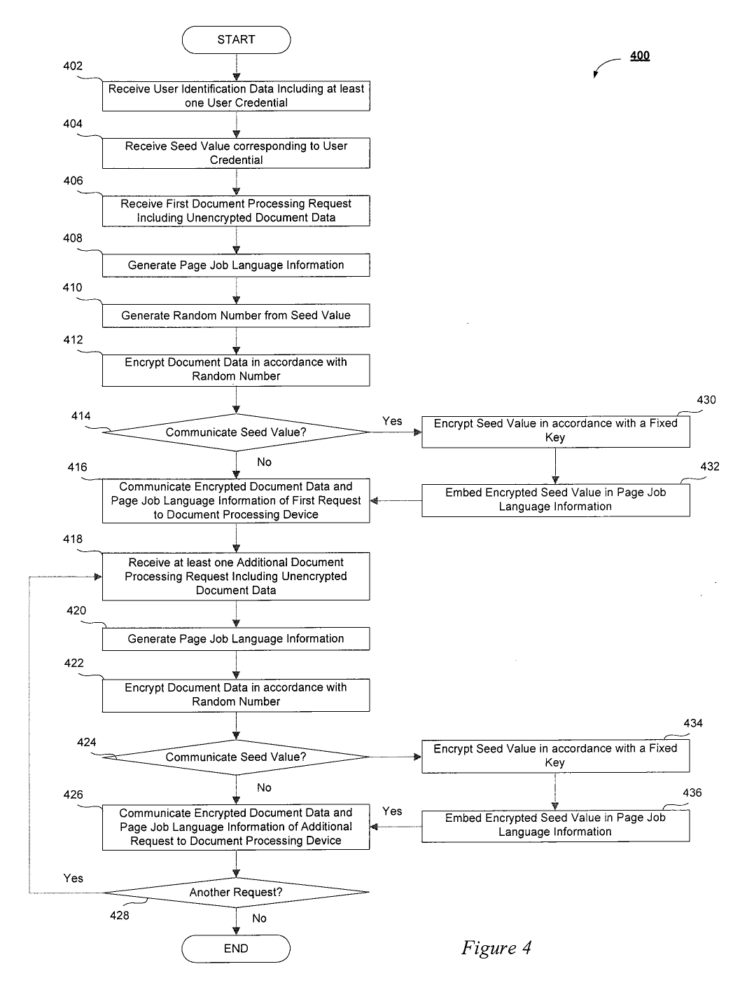

Turning now to FIG. 4, there is shown a flowchart 400 illustrating an encryption portion of a method for securely communicating electronic documents to an associated document processing device in accordance with one embodiment of the subject application. The methodology begins at step 402, whereupon user identification data representing at least one user credential is received from an associated user at a user device 108. It will be appreciated by those skilled in the art that such receipt is capable of being accomplished via the user interface 112, as illustrated in FIG. 1. A seed value is then received corresponding to the at least one user credential associated with the received user identification data at step 404. According to one embodiment of the subject application, the seed value is representative of a 32-bit sequence, or other suitable seed value as will be understood by those skilled in the art.

At step 406, a first document processing request is then received at the user device 108 that includes at least one unencrypted electronic document. It will be appreciated by those skilled in the art that such an electronic document includes, for example and without limitation, an electronic mail message, a word processing document, a spreadsheet document, and an image. In accordance with one embodiment of the subject application, the document data is representative of a plurality of electronic documents, each of which are encrypted in accordance with the methodology set forth hereinafter. Page job language information corresponding to the first document processing request is then generated by the user device at step 408. According to one embodiment of the subject application, the page job language information is suitably configured for controlling operation of an associated document processing device 102.

The user device 108 then generates a random number from the seed value associated with the user credential at step 410. Preferably, the random number is generated in accordance with a preselected algorithm, as set forth in greater detail above with respect to FIG. 2. At step 412, the document data is then encrypted using the random number so as to generate encrypted document data. At step 414, a determination is made whether the seed value is to be communicated in association with the first document processing request to the document processing device 102. Upon a positive determination at step 414, flow progresses to step 430, whereupon the seed value is encrypted in accordance with a fixed key. The encrypted seed value is then embedded in the page job language information associated with the first document processing request at step 432.

Following embedding of the seed value at step 432, or upon a determination that no communication of the seed value is required, flow proceeds to step 416. At step 416, the encrypted document data and page job language information associated with the first document processing request are communicated, via a user interface 112 of the user device 108 to a document processing device 102. The skilled artisan will appreciate that when the page job language information includes an embedded encrypted seed value, such seed value is also communicated to the document processing device 102 at step 416. At step 418, at least one additional document processing request is then received at the user device 108, the request inclusive of electronic document data representing an unencrypted electronic document. Page job language information for the control of the document processing device 102 is then generated corresponding to the at least one additional document processing request at step 420. The document data is then encrypted at step 422 in accordance with the random number so as to generate encrypted document data. A determination is then made at step 424 whether communication of the seed value to the document processing device is required. That is, whether or not the seed value associated with the user credential must also be sent to the document processing device 102.

The encrypted document data and page job language information associated with the additional document processing request are then communicated to the document processing device 102 at step 426. A determination is then made at step 428 whether another document processing request has been received from the associated user via the user device. Upon a positive determination, operations return to step 418, whereupon an additional document processing request is received. Operations continue thereafter as set forth above. When it is determined at step 428 that no additional document processing requests are forthcoming, operations of the subject application with respect to FIG. 4 terminate.

Returning to step 424, upon a positive determination that communication of the seed value is desired, operations proceed to step 434, whereupon the seed value is encrypted in accordance with the fixed key as set forth in greater detail above. The encrypted seed value is then embedded in the page job language information associated with the document processing request at step 436. Thereafter, flow returns to step 426 for communication of the request to the document processing device 102. It will be appreciated by those skilled in the art that the encryption and communication of the seed value illustrated in FIG. 4 is shown for example purposes only, and the subject application is capable of implementation whereby the seed value is not communicated with the page job language information.

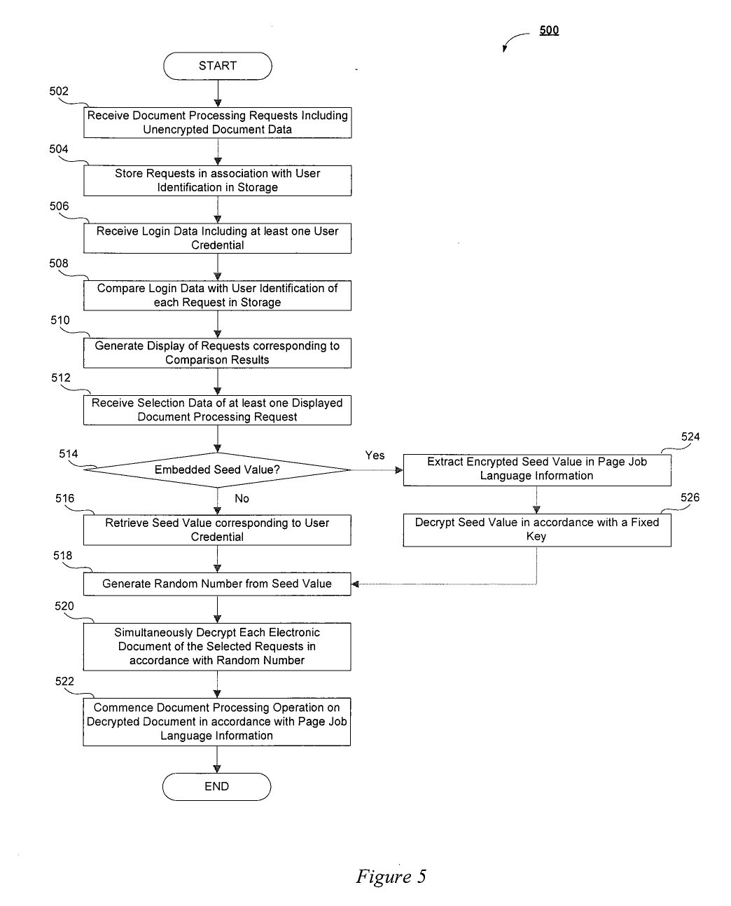

Referring now to FIG. 5, there is shown a flowchart 500 illustrating a decryption portion of a method for securely communicating electronic documents to an associated document processing device in accordance with one embodiment of the subject application. At step 502, the document processing device 102 then receives the encrypted document data and page job language information associated with each document processing request via a document processing device user interface. Each received document processing request is then stored at the document processing device 102 in association with user identification data at step 504. Preferably, the received requests are securely stored in the associated data storage device 126 communicatively coupled to the document processing device 102. Login data is then received at step 506 via the user interface that includes at least one user credential.

At step 508, the login data is compared to user identification data associated with each stored document processing request. It will be appreciated by those skilled in the art that such comparison is capable of being performed by the controller 104 or other suitable component associated with the document processing device 102. The document processing device user interface then generates, at step 510, display data representing each document processing request in accordance with the results of the comparison.

Selection data is then received from the associated user at step 512 corresponding to at least one displayed document processing request. In accordance with one embodiment of the subject application, the user is capable of selecting multiple document processing requests displayed on the user interface of the document processing device 102, such that all secured, i.e. encrypted documents, are capable of being selected for output by the document processing device 102. A determination is then made at step 514 whether the at least one selected document processing request includes an embedded encrypted seed value. That is, whether or not the document processing device 102 is to retrieve the seed value from the request itself, or via the at least one received user credential. When it is determined that the seed value is not embedded in the page job language information associated with the selected request, operations progress to step 516.

At step 516, at least one seed value corresponding to the at least one use credential is retrieved by the document processing device. From the seed value retrieved at step 516, the document processing device generates a random number at step 518. Each encrypted electronic document corresponding to the received selection data is then simultaneously decrypted by the document processing device 102, e.g. the controller 104 or other suitable component associated therewith, at step 520 in accordance with the generated random number. The skilled artisan will appreciate that such simultaneous decryption occurs for each document associated with a specific document processing request, or alternatively occurs for each document processing request irrespective of the number of encrypted electronic documents associated with each. At step 522, a document processing operation is then commenced on each decrypted electronic document in accordance with a received document processing request and associated job page language information.

Returning to step 514, upon a determination that the seed value is embedded in the page job language information associated with the selected document processing request, flow progresses to step 524. At step 524, at least one encrypted seed value is extracted from the associated page job language information corresponding to the selected document processing request. The encrypted seed value is then decrypted by the controller 104 or other suitable component associated with the document processing device 102 using the fixed key at step 526. Operations return to step 518, whereupon a random number is generated and decryption continues through steps 520 and 522 as set forth above.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed is:

1. A system for securely communicating electronic documents to an associated document processing device comprising:
means adapted for receiving, from an associated user at a user device, user identification data representative of at least one user credential associated therewith;
means adapted for receiving a seed value corresponding to the at least one user credential associated with the received user identification data;
means adapted for receiving, at the user device, a first document processing request, which document processing request includes document data representative of an unencrypted, electronic document;
means adapted for generating, at the user device, page job language information, which page job language information is adapted to control operation of an associated document processing device, in accordance with the received first document processing request;
means adapted for generating, at the user device, a random number from the seed value associated with the at least one user credential;
means adapted for encrypting, at the user device, the document data in accordance with the random number so as to generate encrypted document data;
means adapted for communicating the encrypted document data and page job language information associated with the first document processing request to an associated document processing device via a user interface associated with the user device;
means adapted for receiving, at the user device, at least one additional document processing request, which additional document processing request includes document data representative of an unencrypted, electronic document;
means adapted for generating, at the user device, page job language information, which page job language information is adapted to control operation of an associated document processing device, in accordance with the at least one additional document processing request;
means adapted for encrypting, at the user device, the document data associated with the at least one additional document processing request in accordance with the random number so as to generate encrypted document data; and
means adapted for communicating the encrypted document data and page job language information associated with the at least one additional document processing request to an associated document processing device via a user interface associated with the user device.

2. The system of claim 1, further comprising:
means adapted for receiving, at a document processing device user interface associated with the associated document processing device, encrypted document data and page job language information associated with each communicated document processing request;
storage means adapted for storing, at the document processing device, each of the received document processing requests, inclusive of encrypted document data and associated page job language information, in association with user identification data;
means adapted for receiving, via the document processing device user interface, login data from an associated user inclusive of at least one user credential;
comparison means adapted for comparing the received login data to user identification data associated with each stored document processing request;
means adapted for generating, via the document processing device user interface, display data representative of each document processing request associated with the user identification data in accordance with an output of the comparison means;
means adapted for receiving, from the associated user, selection data representative of at least one document processing request displayed on the document processing user interface for output thereby;
means adapted for retrieving at least one seed value corresponding to the at least one user credential;
means adapted for generating, via the document processing device, a random number from the at least one retrieved seed value associated with the at least one user credential;
means adapted for decrypting, via the document processing device, each encrypted electronic document in accordance with the generated random number corresponding to received selection data; and
means adapted for commencing a document processing operation on each decrypted electronic document in accordance with a received document processing request and job page language information associated therewith.

3. The system of claim 2, further comprising:
means adapted for receiving, from the associated user, selection data representative of a plurality of document processing requests having an associated plurality of encrypted electronic documents associated therewith displayed via the document processing device user interface;
means adapted for simultaneously decrypting, via the document processing device, each of the plurality encrypted electronic documents in accordance with the generated random; and
means adapted for commencing each of a plurality of document processing operations on each decrypted electronic document in accordance with each of the plurality of selected document processing requests and job page language information associated therewith.

4. The system of claim 2, wherein the seed value is a 32 bit sequence.

5. The system of claim 2, further comprising:
means adapted for receiving, at the user device, a document processing request including document data representative of a plurality of electronic documents;
means adapted for encrypting each of the plurality of electronic documents in accordance with the generated random number so as to generate a plurality of encrypted electronic documents; and
communication means adapted for communicating the plurality of encrypted electronic documents and associated page job language information of the document processing request to the document processing device.

6. The system of claim 2, wherein the login data includes at least one of a username and a password.

7. The system of claim 2, wherein the at least one user credential corresponds to at least one of the group consisting of a username, a certificate, and a password.

8. The system of claim 2, wherein the electronic document comprises at least one of the group consisting of an electronic mail message, a word processing document, a spreadsheet document, and an image.

9. The system of claim 2, further comprising:
means adapted for encrypting, at the user device, the seed value in connection with fixed key data;
means adapted for embedding, at the user device, the encrypted seed value in job control data associated with the encrypted document data and the document processing request; and
means adapted for communicating the encrypted document data and job control instructions inclusive of the embedded encrypted seed value to an associated document processing device via a user interface associated with the user device.

10. The system of claim 9, further comprising:
means adapted for extracting, via the document processing device, the encrypted seed value from the job control instructions;
means adapted for decrypting, via the document processing device, the extracted encrypted seed value in accordance with a copy of the fixed key data in the data storage; and
means adapted for generating, via the document processing device, a random number from the decrypted seed value.

11. A method for securely communicating electronic documents to an associated document processing device, comprising the steps of:
receiving, from an associated user at a user device, user identification data representative of at least one user credential associated therewith;
receiving a seed value corresponding to the at least one user credential associated with the received user identification data;
receiving, at the user device, a first document processing request, which document processing request includes document data representative of an unencrypted, electronic document;
generating, at the user device, page job language information, which page job language information is adapted to control operation of an associated document processing device, in accordance with the received first document processing request;
generating, at the user device, a random number from the seed value associated with the at least one user credential;
encrypting, at the user device, the document data in accordance with the random number so as to generate encrypted document data;
communicating the encrypted document data and page job language information associated with the first document processing request to an associated document processing device via a user interface associated with the user device;
receiving, at the user device, at least one additional document processing request, which additional document processing request includes document data representative of an unencrypted, electronic document;
generating, at the user device, page job language information, which page job language information is adapted to control operation of an associated document processing device, in accordance with the at least one additional document processing request;
encrypting, at the user device, the document data associated with the at least one additional document processing request in accordance with the random number so as to generate encrypted document data; and
communicating the encrypted document data and page job language information associated with the at least one additional document processing request to an associated document processing device via a user interface associated with the user device.

12. The method of claim 11, further comprising the steps of:
receiving, at a document processing device user interface associated with the associated document processing device, encrypted document data and page job language information associated with each communicated document processing request;
storing, at the document processing device, each of the received document processing requests, inclusive of encrypted document data and associated page job language information, in association with user identification data;
receiving, via the document processing device user interface, login data from an associated user inclusive of at least one user credential;
comparing the received login data to user identification data associated with each stored document processing request;
generating, via the document processing device user interface, display data representative of each document processing request associated with the user identification data in accordance with an output of the comparing step;
receiving, from the associated user, selection data representative of at least one document processing request displayed on the document processing user interface for output thereby;
retrieving at least one seed value corresponding to the at least one user credential;
generating, via the document processing device, a random number from the at least one retrieved seed value associated with the at least one user credential;
decrypting, via the document processing device, each encrypted electronic document in accordance with the generated random number corresponding to received selection data; and
commencing a document processing operation on each decrypted electronic document in accordance with a received document processing request and job page language information associated therewith.

13. The method of claim 12, further comprising the steps of:
receiving, from the associated user, selection data representative of a plurality of document processing requests having an associated plurality of encrypted electronic documents associated therewith displayed via the document processing device user interface;
simultaneously decrypting, via the document processing device, each of the plurality encrypted electronic documents in accordance with the generated random; and
commencing each of a plurality of document processing operations on each decrypted electronic document in accordance with each of the plurality of selected document processing requests and job page language information associated therewith.

14. The method of claim 12, wherein the seed value is a 32 bit sequence.

15. The method of claim 12, further comprising the steps of:
receiving, at the user device, a document processing request including document data representative of a plurality of electronic documents;
encrypting each of the plurality of electronic documents in accordance with the generated random number so as to generate a plurality of encrypted electronic documents; and
communicating the plurality of encrypted electronic documents and associated page job language information of the document processing request to the document processing device.

16. The method of claim 12, wherein the login data includes at least one of a username and a password.

17. The method of claim 12, wherein the at least one user credential corresponds to at least one of the group consisting of a username, a certificate, and a password.

18. The method of claim 12, wherein the electronic document comprises at least one of the group consisting of an electronic mail message, a word processing document, a spreadsheet document, and an image.

19. The method of claim 12, further comprising the steps of:
encrypting, at the user device, the seed value in connection with fixed key data;
embedding, at the user device, the encrypted seed value in the page job language information associated with the encrypted document data and the document processing request; and
communicating the encrypted document data and page job language information inclusive of the embedded encrypted seed value to an associated document processing device via a user interface associated with the user device.

20. The method of claim 19, further comprising the steps of:
extracting, via the document processing device, the encrypted seed value from the job control instructions;
decrypting, via the document processing device, the extracted encrypted seed value in accordance with a copy of the fixed key data in the data storage; and
generating, via the document processing device, a random number from the decrypted seed value.
